(19) United States
(12) Patent Application Publication
(10) Pub. No.: US 2014/0364202 A1
(43) Pub. Date: Dec. 11, 2014

(54) Computer Enabled Application for Nutrition and Advertising

(71) Applicants: Donn K. Harms, Carlsbad, CA (US); Nargiz Makhsudova, Carlsbad, CA (US)

(72) Inventors: Donn K. Harms, Carlsbad, CA (US); Nargiz Makhsudova, Carlsbad, CA (US)

(21) Appl. No.: 14/300,868

(22) Filed: Jun. 10, 2014

Related U.S. Application Data
(60) Provisional application No. 61/833,383, filed on Jun. 10, 2013.

(51) Int. Cl. A63F 13/00

(52) U.S. Cl. CPC A63F 13/00; A63F 2300/609
USPC 463/29

(57) ABSTRACT

The game method and system herein disclosed and described provides a game and game system and method configured for operation on a user's computing device such as a personal computer, pad, laptop, or smartphone. The user then interacts and progresses through the game through a scanning of a product label or container. The product or container and label thereon itself, can be employed as a trigger to start the game and is preferred since the demographics of product buyers and users can help determine the user's age and other economic elements of the user which in turn can affect what game is presented for play, and what advertising is displayed during that play by the user.

This application is a U.S. Nonprovisional patent application based on U.S. Provisional Application No. 61/833383 filed on Jun. 10, 2013, and is incorporated herein in its entirety.

### BACKGROUND OF THE INVENTION

1. Field of the Invention

The present invention relates to video games employed for play on computers, smartphones, tablets, and other computing devices. More particularly, it relates to a computer game, which is configured for triggering to boot and/or operate, based on a viewing of a product label or product container in the viewing screen of the smartphone. Once triggered to activate, the game can elicit user interaction during play where points or garnered credits may be required for additional product consumption or purchase. Finally, the system and method herein provide advertising space to sponsors on billboards situated about the differing screens of the game and the ads may vary depending on the ascertained user of the game and may be inserted in real time.

2. Prior Art

Conventionally, video games for desktop computers, and the like, and for gaming machines having computing onboard and other computer devices are purchased on media adapted to load to a computing device, or are downloaded on a network connection to a computing device. Other games are playable using a networked connection to a website hosting the online game for one or a plurality of users in a game session.

More recently, with the advent of smartphones and pad computers, games are downloaded as applications to the computing device on the smartphone. However, the vast majority of such applications or games operate with a single set of game characters or icons and on set game courses or levels. To move and advance the user's icon or game piece through the levels a user will interact using an input device while viewing a video display providing feedback of the user's character or icon moving through tracks or courses.

The user employing an input component such as a joystick, mouse, accelerometer, touch to the screen, or other modes, while viewing the video display feedback generated by the software operating the game, manipulates the input to move their game piece or icon or other visual representation of the user depicted on the screen. So interacting, the user will traverse through a course or track or the like, to reach a goal at the end of a current course or track, to move to another higher level of the game, or to move to other levels or types of environments for the game. The higher levels requiring more skill and perhaps more weapons or other skill, are usually reached when the play has sufficient points, and stored assets such as weapons or lives, to move to such a higher level in the game.

However, such games employed on computing devices, generally are unitary in the game characters and game goals and the like and do not adjust the entire game and the video depictions generated for input by the user, based on a determined age level, unless the user is asked to input such. Further, such computer enabled software driven games do not change the depicted video seen and interacted with by the user, to render indicia of interest to the individual user by age or residence or other demographics, even if the age and/or demographic aspects of the user are known. Still further such existing software games enabled on computing devices for user interaction, do not provide embedded advertising or real time communicated advertising for advertisers, which are viewable on the course or track in the graphic depictions employed for user interaction. Neither do such present games employ products as triggers or as an alternative means to reach other game levels for the user. This is so even though users and advertisers and product suppliers may all benefit from such.

As such, there is a continuing unmet need for an improved game method and operation when loaded, enabling computing systems such as on smartphones or pad computers, or regular PC's, which will change the depicted video and game goals and operation, based on a product being the trigger for the game, and/or an age determination of the user based on the product triggering the game. Such a gaming system should enable the system to ascertain the user's age at a minimum by employing a product or product label as the trigger for enabling the game to start.

Based on the product employed to trigger the game, such a gaming system should be configured provide a depicted game oriented for the user, based on the ascertained age and/or financial, and/or residence or other demographics which are related by the game system and provider to the product providing the trigger. Finally such a game system should be enabled to provide imbedded or real time advertising within the video projected on the display during user interaction in operation of the game for while interacting with the game software to move through course and levels of the game.

### SUMMARY OF THE INVENTION

The game method and system herein disclosed and described provides a solution to the shortcomings in prior art, and achieves the above noted goals through the provision of a game and game system and method configured for operation on a user's computing device such as a personal computer, pad, laptop, or smartphone. In operation in one preferred mode, the game is triggered to start, and thereafter allows user interaction and viewing using an input device to maneuver through the game tracks, or courses or levels, through a scanning of a product label or container. The product or container and label thereon itself, can be employed for the trigger and is preferred since the demographics of product buyers and users can help determine the user's age and other economic elements of the user which in turn can affect what game is presented for play, and what advertising is displayed during that play by the user.

In operation to an as-used state where the user may use an input device or means, such as a joystick, mouse, accelerometer or the like, to move through the depicted courses, tracks or levels of the game. The game and system is triggered to operate by the scanning or viewing of the product or label which is communicated to the microprocessor of the device an interfaced with software adapted to load and operate the game.

In the case of a smartphone, the placement of a product such as soda in front of the camera, the captured image is compared locally or over a network, to a relational database of such product and label images, to determine if a match to a product has been made. Other product specific identifiers may be placed on the label such as an image “fingerprint” which is an image buried in the original image and computer discernible. A UPC code on the product might work to identify the product itself, however it is unlikely manufacturers will obtain a separate UPC code for each product bearing each character and thus the indicia of the label or printed product label on the container will work much better for letting a user choose a character to use to trigger the game and insert that character also. Once a match to a particular product, say for instance an energy drink or a soda pop, is made, the system will load, and/or start the game on the user's computing device, which relates to the discerned product or label.

Once a match to trigger the game and system is determined, the software will run on the computing device, for instance a smartphone or pad computer, and provide video depictions of game scenes, tracks, courses, and levels thereof and the like, for the user to interact with using the engaged input device.

In one preferred mode, it is the actual product used for the trigger which will determine the actual graphic depictions the software will communicate to the video screen for user interaction during play. In this mode, one of the characters in the game, from a plurality of potential characters in the game, is depicted on the label of the product. Thus when the user places the label with the individual character in the camera view, the game that starts will be one related to the character, and, the user will be that character in the game. The rest of the characters in the game will also be depictions on product labels such that a user may purchase the product bearing the label of his or her favorite character, and, that is the character that user will have when they start the game with the product or label.

This mode is especially well adapted for children, who may have a favorite character from the plurality in the game and on a related TV show and the like. By purchasing and/or drinking a container of the product bearing the character of choice, the user can become that character for the game. Friends, such as other children, can be other characters from the plurality by simply scanning in a product or label having the desired character thereon. To insure the product has been opened, a code or number only visible on the inside of the product label or under the cap of the product, or in another position requiring product opening may be required. This will insure the user opens a new bottle or can of product for consumption for each game.

The product may be a soda, or a natural juice, or a vitamin enriched liquid, or milk, or an energy drink, or another product. The game may be a boon to parents wishing to have their children eat or drink the product required to start the game, or for advertisers who may have products to sell and who may provide the game online for users purchasing and scanning the product label or container to start the game.

For instance in a very simple mode for small children, the character on the product label or container, may trigger a video display of the same character dancing and/or singing which re-starts each time the product label or container bearing the character is placed in camera view. With older children or adults, the product label or container may trigger the start of more mature games requiring some dexterity and game-know-how to play.

During play of the game, based on the ascertained user age and other demographics which may be discerned on many occasions fro the very product being scanned or label thereon, in one preferred mode, advertising is placed on signs which are on the “course” or game levels being traversed by the user interacting with the game. This advertising may be related to the product which started the game, or not, or may be determined of interest to players who uses a particular product to start and use the game. Thus, a user who uses a child's soda will get a child's game along with signs or ads for the child's soda, or related products, or products ascertained of interest to consumers of the child's soda. An older child or adult, on the other hand, may use an energy drink, or beer to trigger the start of the game. Based on that product trigger, the course and characters of the game may be adjusted to a more mature game and course. The advertising in real time would be for products deemed related to the trigger product, or products known or discerned to be of interest to users who have used a particular trigger product.

For instance, the child may get a game about the three bears, while a teen or adult using beer or an energy drink, might get a game where weapons are used on differing levels. In the child's game, advertising may be for children's toys or products, while in the teen or adult game, the advertising may be for other alcoholic beverages, designer clothing, or other products deemed of relational interest to users triggering the game with a particular product.

The products may also be used as an adjunct to scoring points and capturing weapons and energy and the like required to move forward in the game and/or change levels of play. Frequently game players must store weapons or components they find or capture or earn in a game, for use later in other game levels or to reach those levels. Using the game method and system herein, once users start the game with a product, they may optionally be offered the ability to augment their scores and ability to move into other game levels, by using or buying more product, or by visiting a site related to the game, and purchasing points or “power” or other items required in the virtual game world to progress.

Of course, such would be determined by the initial product used to start the game. If a product manufacturer wishes to have the user's only earn their way to other levels in the game, that is one manner of the system. However if the product manufacturer wants to sell other product, or game points, or to award them for product purchases, or as prizes, that is envisioned as part of the game method herein. It would be the original product triggering the start of a product related or associated game, which would start the user down the path of the particular related game, and the rules required by the product manufacturer or advertiser related to the product.

As another example, for an adult version, if the product were sunglasses and the user scanning the sunglass tag starts the game, the advertising may be for clothing by the same or a related form to that of the sunglasses. The characters and playing levels of the game would be more adult than the child's soda pop triggered game. Further, because the players are older, the sunglass manufacturer or advertiser may leave the rules and advances up to the network provider hosting the programming for the game as to any purchased points or game attributes needed to advance as part of an offset for paying for the advertising in the first place. In this mode, the hosting site for the server interfacing with the game once started, may have the privilege of selling the user extra points, equipment, weapons, or other virtual assets needed to progress.

For instance, if the user triggered the game with sunglasses, and the sunglass advertiser wants to lower the ad cost, they may allow their trademark to be used to trigger the game, and thereafter send advertisements to game billboards in real time, or have them embedded. However, during game play, the system provider will be allowed to sell points and other virtual assets allowing the user to advance in the game. For example changing from a race track to under water in the virtual site of the game, the user might need scuba equipment they have not earned. They would have the ability to buy the equipment and move to the water filled level of the game if they wish, rather than earning points to do so in this mode of the game. The product manufacturer or advertiser for the original sunglasses which triggered the game, would get a discount on the ad rates, since the service provider will recoup some costs selling virtual assets to gamers.

As can be seen, using the product container or label, to trigger the game, and to determine what game, what type of game, and to include a character printed on the product label, as that user's figure or character within the started game, allows great versatility to the provider of the game and network connection and/or server in providing games and advertising to users on behalf of product manufacturers.

A natural kid's juice manufacturer or advertiser can have a game which is for small children in content and complexity and which may include a character from the label or package, in the game itself, on behalf of the user starting the game with the product. On the other hand, an energy drink or beer manufacturer or advertiser, may have a game depicted on the user's device, which is more adult in nature and may be related to the more adult product if desired.

Advertising may or may not be displayed on the game courses, however if displayed, the product triggering the game, and the type and characters, may also determine the products and services imbedded or communicated in real time over a network, for display on the game courses and levels.

With respect to the above description, before explaining at least one preferred embodiment of the game and advertising system and method herein disclosed invention in detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other games, interactions with products, and methods and systems for carrying out the several purposes of the present disclosed system and method. It is important, therefore, that the claims be regarded as including such equivalent construction and methodology insofar as they do not depart from the spirit and scope of the present invention.

It is an object of the invention to provide a system for provision of electronic game play to users, which is triggered by scanning a product or service label or container with the camera engaged to a computing device such as a smartphone.

It is a further object of this invention, to render the characters and content of the game triggered, related to or limited by the product triggering the game.

It is a further object of this invention to provide such a game system, which further communicates advertisements in real time to game course billboards, that advertising being triggered by or related to the product triggering the game.

### BRIEF DESCRIPTION OF DRAWING FIGURES

FIG. 1 shows an example of the system where a smartphone or pad computer captures the image of a product using the camera of the device.

FIG. 2 depicts a removable container seal such as a cap, having a secondary code or identifier thereon which may be input by the user to show product consumption.

FIGS. 3-5 continues the example of FIG. 1 showing the character from the label, in a simple game or video, dancing or moving in the user's rendition of the game.

FIG. 6 depicts a mode of the system where the depicted game has advertising related to the product used to trigger the game, such as the soda of FIG. 1.

FIG. 7 depicts the game herein wherein the billboards are imbedded with, or, have ads communicated in real time, which are related to or activated by the triggering the game with a product.

FIGS. 8-11 depict an example of a plurality of characters for a particular game which may be activated as the user's character in the game, by triggering the game with a product bearing a label or indicia bearing the individual character.

FIG. 12 depicts a mode of the system where the trigger for the game and its type and content, is an energy drink.

FIG. 13 depicts another product trigger for the game having a different character thereon, which may also be used to buy points, weapons, or other assets for example.

FIG. 14 depicts a canned product having a label which triggers a game to start on a computer such as a smartphone, and can be used to trigger a purchase of game assets for instance and/or to inject the label character into the game played.

### DETAILED DESCRIPTION OF THE PREFERRED EMBODIMENTS OF THE INVENTION

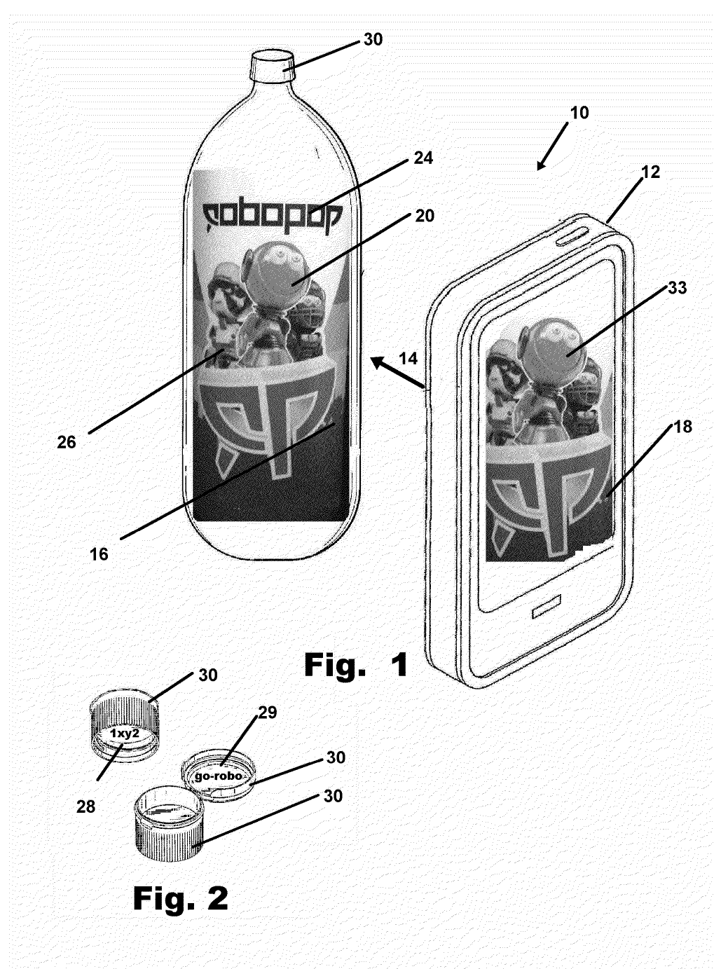

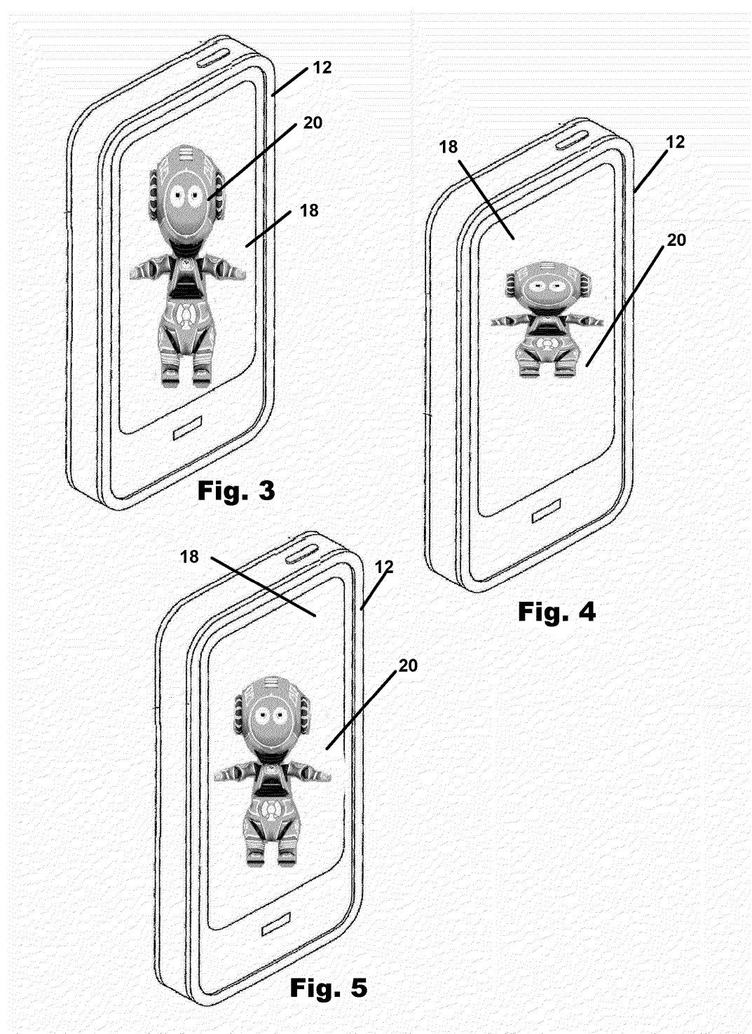

In a preferred modes of the device of the depictions in FIGS. 1-14, thee is seen in FIG. 1, the system 10 herein employing a product label or container or indicia on a product package, to trigger a game or software on a computer such as the smartphone 12, having a camera 14 to render the indicia of the label 16 or container to a video screen 18. As shown in FIG. 1 smartphone 12 or pad computer captures the image of a product using the camera 14 and renders it to the screen.

In an example of a small child's game, of FIGS. 3-5, where the character 20 on the label, becomes the character 20 on the screen and/or in the game for the user. As seen in FIGS. 3-6, the character 20 dances on the screen 18 once the camera 14 communicates indicia from a container or label for a product, which when looked up over a network or on the phone using software adapted to discern images or symbols and relate those to games and/or advertising, and or game content, and the like in a database thereof.

In this case in FIGS. 3-5, the character 20 was recognized and inserted into the game depiction on the screen 18, and the content of the game was adjusted to a small child and the character simply dances to music played while the character dances on the screen 18. Other identifying indicia on the label may be the product name 24, or a digital fingerprint 26 imbedded in the printing of the label or indicia, which is discernible by software adapted to the task but substantially invisible to the buyer or user.

For modes of the game and system where product consumption may be desirable, such as to buy game credits, assets, points, or skip game levels, or move to game levels, a secondary code 28 or identifier 29 may be positioned on the product which would require opening the product to scan with the camera 14, or view and input to the game or system. In FIG. 2, the cap 30 for a consumable liquid product is shown removed to provide proof of use of the product should such be required for extra game points or assets and the like.

FIG. 6 depicts a mode of the system 10 where the depicted game on the screen 18 has been adjusted to a more mature or harder game than that of FIGS. 3-5 and showing that element of the system 10. Also shown is the embedded advertising 32. The character 33 from FIG. 10 may have been on the indicia of the product packaging or label and thus made the user's character 33 in the game, and thus chosen by the user by using that individual product package.

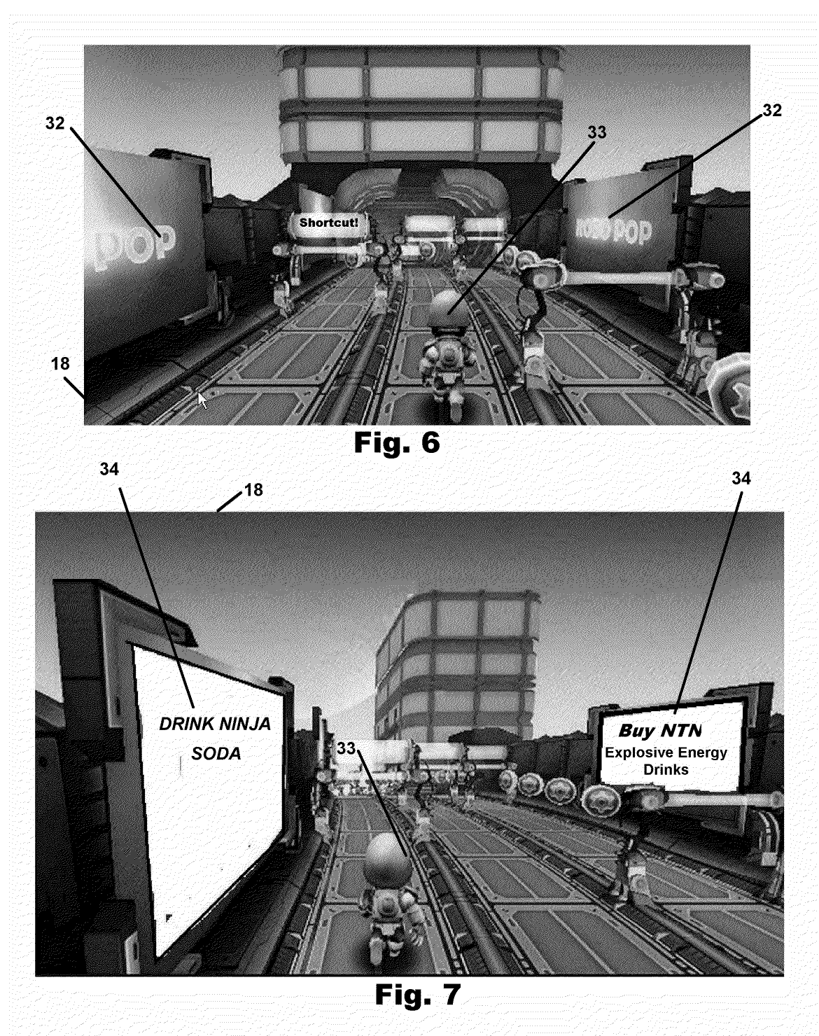

FIG. 7 depicts the system 10 herein wherein the billboards are imbedded with real time advertising 34 which may be communicated to the game while running, or injected to the game when downloaded to the user's smartphone 12, or other computing device such as a pad, laptop, or personal computer. In this mode the user demographics have been determined such as one or a combination of age, income, interests, locale, education, ethnic background, or other demographic factors determined to be related to the particular indicia, on the container or label of the product, that user placed in the camera 14 field of view to intentionally activate or trigger the game of the system 10.

The advertising 34 may be for products of the same manufacturer as the triggering product, or related thereto, or from advertisers who wish their ads displayed to users who trigger the game with a particular product. The ads 32 and 34 may change with each passing of a billboard during play, at change of game level, or they may be static. The advertisements may be downloaded to the user device or smartphone 12 during downloading of the game or software and stored for use on cue by the software, or preferably may be communicated in real time thereby allowing for changes to advertisements 34 based on the advertiser's instructions, or based on the level of the game reached, and/or decisions by the user during the game which have been determined to favor ads for one or another product or service.

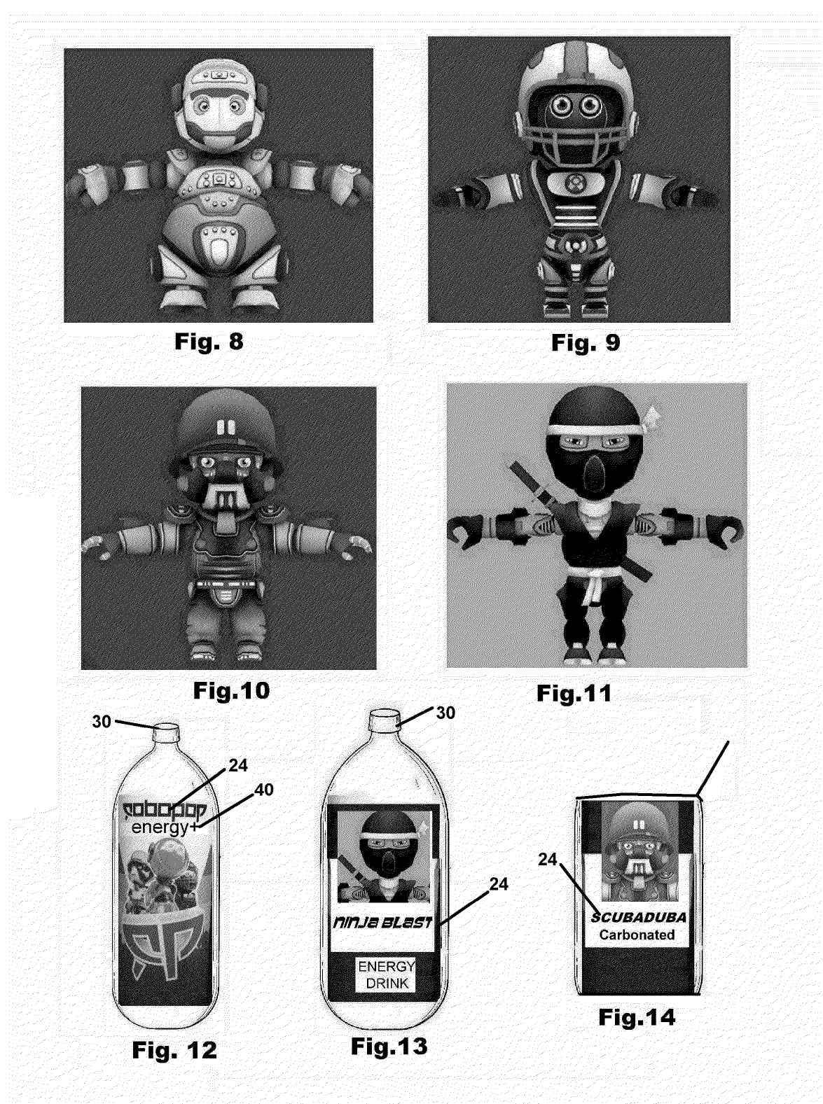

FIGS. 8-11 depict an example of a plurality of characters for a particular game or software, which may appear singularly or in combination on product packaging or labels, which may be chosen by the user to activate the game and pick their individual character in the game. Thus users having an affinity for the ninja of FIG. 11, would endeavor to have products bearing that character as a trigger for game sessions.

FIG. 12 depicts a mode of the system 10 where the trigger for the game and its type and content, may be an energy drink 40. Or, the energy drink 40 may be related to the product of FIG. 1, and used to show secondary purchase to buy awards, points, or game assets.

FIG. 13 depicts another product trigger for the game having a different character thereon from FIG. 11, which may be purchased by a user to obtain that character and traits in the game, or, which may also be used to buy points, weapons, or other assets for example. As with the products of FIGS. 1, 12, and 14, the user would place them in camera 14 view and software adapted to product recognition would ascertain the product and the related game levels, characters, advertising etc. to be included in a game or session triggered thereby. If for instance the energy drink of FIG. 13 were an adult drink, then the triggered game related to that drink would be more mature as would the imbedded advertising 32 and/or real time advertising 34.

FIG. 14 depicts a canned product having indicia on a label which triggers a game to start on a computer such as a smartphone. In this case the product has carbonation which for instance might shown by a user to the camera 14 and discerning software, to show secondary purchase to get air-tanks as an asset to proceed to a water oriented game level. The character 33 in this instance is that of FIG. 10 and has a breathing mask on also.

Again, any of the elements noted herein may be employed with any of the others or without, in the system 10 herein which employs software-discerned camera 14 scans of product indicia on containers or packages to trigger software such as game play, and/or to adjust the characters and level of play, and/or advertising within the displayed game.

While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention. Consequently, all such modifications and variations and substitutions are included within the scope of the invention as defined by the following claims.

What is claimed is:

1. A system employing product container or label indicia to trigger or activate a game for play on a user computing device, as shown and described.
